(19) United States
(12) Patent Application Publication
(10) Pub. No.: US 2004/0194139 A1
(43) Pub. Date: Sep. 30, 2004

(54) Interactive on-screen electronic programming guide display, method and system

(75) Inventors: Vishnu Kumar Shivaji Rao, Vancouver, WA (US); Mark G. Hanley, Skamania, WA (US); Gary Feather, Camas, WA (US)

Correspondence Address: Robert D. Varitz, ROBERT D. VARITZ, P.C., 2007 S.E. Grant Street, Portland, OR, 97214, US

(73) Assignee: Sharp Laboratories of America, Inc.

(21) Appl. No.: 10/401,445

(22) Filed: Mar. 27, 2003

(51) Int. Cl. H04N 5/445; G06F 3/00; G06F 13/00

(52) U.S. Cl. 725/52; 725/53; 725/39

(57) ABSTRACT

A system, a methodology and a related, on-screen, interactive user interface which displays electronic programming guide (EPG) text, with highlighted and user-selectable keywords that enable focused, precision informational navigation through the available EPG database. The display also presents different categories of virtual tools that can be employed by a user for navigating purposes, accessible via a suitable remote, hand-held control device.

### BACKGROUND AND SUMMARY OF THE INVENTION

This invention pertains to the presentation and use of an available electronic programming guide (EPG) database. More particularly, it pertains to a system, to a user interface implemented by that system, to methodology related to the utility of that system, and to a specially prepared data stream involved with operation of the system, which enable a user, from an on-screen display in a television receiver, to navigate freely, intuitively, and with great range and versatility through information content contained in such an EPG database.

In general terms, the structures and methodologies proposed and offered by the present invention are based upon the establishment of a library of words which are (a) likely to include substantially all programming-informational words that a “universe” of viewers would select to identify areas of special viewing interest, (b) expected nominally to be present, at least from time-to-time, within and throughout the usual ever-changing, EPG database that is made available television viewers, and (c) therefore most likely to characterize an overall quality of granularity and “topical resolution” which will function well as entry-point navigational keywords capable of mining thoroughly the entire EPG data structure. This library may be a fully initially established and set collection of words, or more preferably, it may be a dynamic collection of words that can be changed from time-to-time in various ways. It may also be such a word collection that is subject to user preferences which may determine which words, or categories of words, are to play a role in the behavior of the invention. Whatever the particular library condition may be at any given point in time, the then “active” words in the library are referred to herein as keywords, and also occasionally as pre-selected keywords.

In the practice of the invention, the content of a current EPG database is relationally compared to the content of this library of pre-selected keywords. This comparison is done in a fashion whereby text portions of the EPG database that are found (from the comparison) to contain these words are designated to be “presentable” as selectable content in an interactive interface which is, under user control, displayable on the screen of a user's television receiver. This on-screen display, when selected, is made to appear in such a manner that any keywords which are present in its text (a) are functionally treated as “active” keywords, (b) are highlighted for recognition as being “active” keywords, and (c) are made functionally accessible, through a user-control instrumentality, such as a hand-held remote-control device, for implementing different kinds of context-related, link-maneuvering navigation through the database.

It will this be seen, that, in accordance with practice of the present invention, the navigational character of the EPG database at any moment in time is effectively entirely and focussedly dependent upon its then actual textual content, as such current content is directly relatable to keyword-activatable words which are also then present in the mentioned library. In other words, if a particular word is present in the library, but either not selected to be activatable as, for example, by implementation of a user preference, or is not currently found anywhere in the EPG database text, it will not present itself in the interface display created by operation of this invention. It will only “be there” when it is relevant, rather than “being there” just because it could at some point in time be useful. This special co-relationship creates a powerful and highly efficient programming-information “mining” tool in the hands of a user wishing to “zero-in”, so-to-speak, on areas of broadcast media interest. The user is thus always presented with just the right character and content of navigational information.

Thus use of the present invention does not introduce the clutter, and sometimes overcomplexity, of traditional menu-driven interfaces. Nor does it require any tedious keystroke-entry of text and/or numbers to gain access to desired informational features in the EPG database. Simple Up, Down, Left, Right, and single-and double-click button actions on, for example, a rather traditionally configured, handheld, remote-control unit, are all the user activities that are necessary.

A preferred embodiment of, and a few manners of practicing, the invention are described herein in the setting of offering users, via fundamentally just a few manipulation modalities, which each offer a somewhat different level of search-and-select, context-related granularity, the opportunity to navigate quickly, intelligently, and effectively through an EPG database. While, therefore, only a modest number of such modalities is specifically illustrated and discussed herein, it will be clearly recognized and understood by those skilled in the art that other, and more, useful, context-related maneuvering capabilities can be employed in accordance with fundamental practice of the invention. As will be seen, there are two preferred, graphically-implemented modes for EPG database search-and-select navigation. One of these two modes involves user manipulation of a scrollbar-like virtual tool with a “slidable” handle which created in an on-screen display that presents a keyword modified database prepared in accordance with practice of this invention. The other mode involves a finer-granularity manipulation/selection via various categorically defined context buttons, or tabs, that identify different specific kinds or regions of information, such as proper names, film titles, different sports, music, avocation topics, special events, political affairs, children's entertainment, and, of course, many other things.

The numerous features and special advantages that are offered by the present invention will become more fully apparent as the description which now follows is read in conjunction with the accompanying drawings.

### DESCRIPTION OF THE DRAWINGS

FIG. 1A is a high-level block/schematic diagram illustrating both the system and the methodology of the present invention, represented in a preferred embodiment and best mode form.

FIG. 1B is a stylized story-telling diagram illustrating the construction and form of a specially modified EPG-derived data stream prepared and brought into existence for use in accordance with practice of the present invention.

FIG. 2 is an instructional diagram illustrating how different groupings of FIGS. 3-31, inclusive, relate to one another in conjunction with describing three kinds of user navigational operations employing the system, and involving the methodology, of the present invention.

FIGS. 3-31, inclusive, whose figure numbers appear in representative blocks presented in FIG. 2, illustrate simulated screen shots of a user's television receiver screen containing an interactive modified EPG data stream display constructed and made operational in accordance with practice of the present invention.

### DETAILED DESCRIPTION OF THE INVENTION

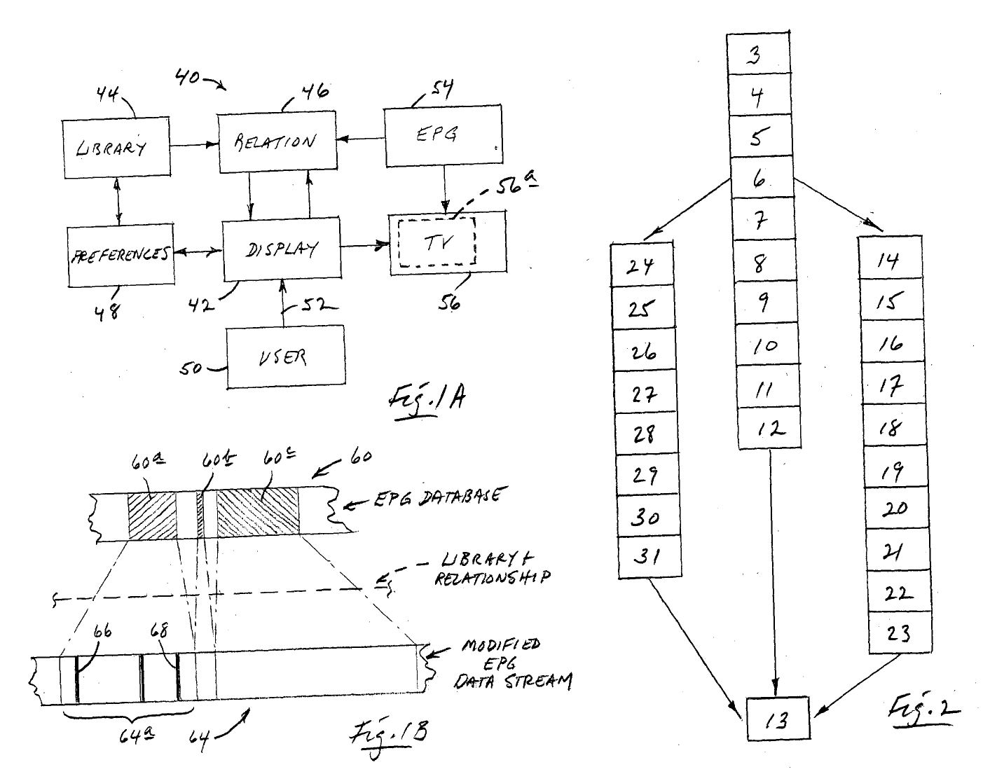

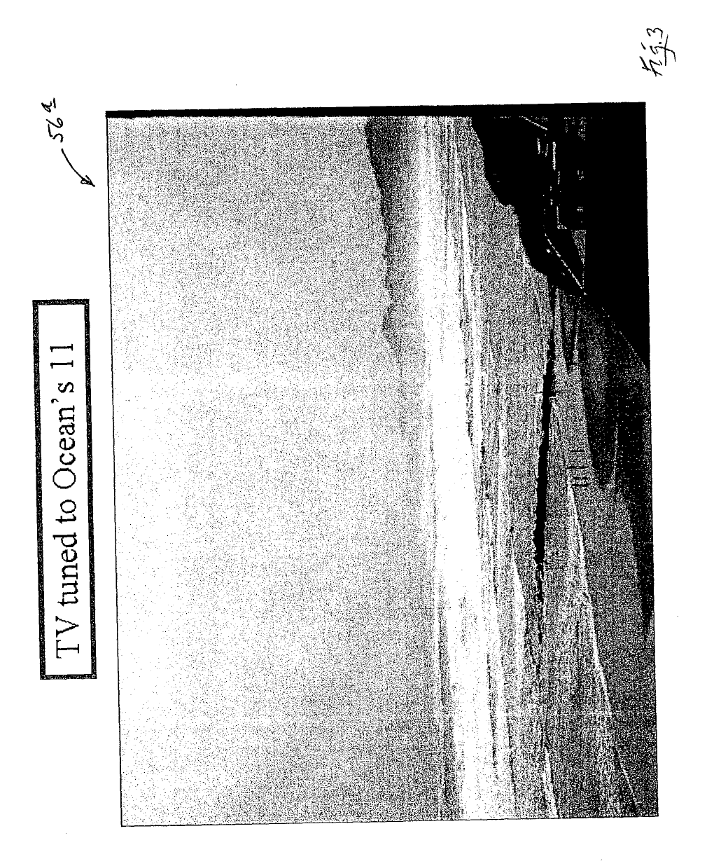

Turning now to the drawings, and referring first of all to FIG. 1, indicated generally at 40 in block/schematic form are both a system, and the relevant methodology associated with that system, constructed in accordance with a preferred and best mode embodiment and manner of practicing the present invention. Included in system 40, as such is pictured in FIG. 1A, are a display control structure 42, a library of pre-selected keywords 44, a relationship structure 46, and a block 48 which enables the implementation, as will be explained, of certain system user preferences. Also included in system 40 is a user selection structure 50 which is operatively connected to the display control structure through an operative connection represented by an arrow 52 in FIG. 1A. This user selection structure preferably takes the form of an appropriate remote control device possessing certain nominally available controls which will be mentioned shortly herein. The precise construction of this user selection structure is not part of the present invention.

Also presented in FIG. 1A are a block 54 which represents an available, input EPG database, which database is conventionally and widely supplied to various television users for the purpose of making available, for on-screen display, running streams of programming content information, and a block 56 which represents a user television receiver having the usual screen 56a. Appropriative operative connections exist between all of the blocks pictured in FIG. 1A, with these connections being represented by appropriate single-or double-headed arrows which generally describe the directions of control and/or information flow between these blocks.

As will become apparent, the actual physical structures and software algorithms, etc., which are present within system 40 for implementing the methodology of this invention may be, and preferably are, internally conventional and well known per se. It is the organization of these constituent elements, as proposed by the present invention, which leads to the special and unique advantages and relationships that characterize the present invention.

Generally describing the functionality of system 40 in the arrangement pictured in FIG. 1A, and recognizing that other specific organizations of components can as well function to provide these areas of functionality, a conventional EPG database is received via block 54, is made available directly (conventionally) to television receiver 56 as shown, and is also furnished to relationship structure 46. This database arrives through block 54 in an unmodified form.

Contained appropriately in library 44, which may be a computer-based memory device, or site, is a preferably relatively large collection of selected words that have been characterized as possible keywords, and that are expected nominally to be present over time within and throughout the usual EPG database. Words in library 44 might take the form, for example, of names of actors and actresses, names of producers and filmmakers, names of musical groups and musical styles, sports events and personalities of various categories, general categorizations of subject matter such as fast-paced action, tragedy, drama, comedy and humor, and so on. These words, as has just been suggested, are expected to be available from time-to-time within the received EPG database, and they are selected to provide versatility relative to user-initiated and implemented navigational transport through the EPG database. With respect to what may constitute a “keyword” herein, such may be either a single word, or an appropriate naturally-associated group of words, such as a person's name.

One of the steps of the invention involves the establishment of library 44, which establishment enables the practice of certain other steps including (a) treating certain ones of these words as so-called navigationally-active keywords, (b) presenting EPG-data text on a user's television screen in the form of keyword-treated text, (c) and enabling user interaction with such presented text to enable program selection for viewing, and/or for producing appropriate navigational changes, and thus information changes, in presented EPG text on the basis of user interaction.

Library establishment may take the very simple form of full and fixed placement of selected words in the library. More preferably, however, library establishment is made to be dynamic, and capable of appropriate changes (enlargement or reduction) over time. Talking about enlargement, this may be done by equipping the library with a certain degree of computer-system intelligence, as through providing for the use of any conventional text-analysis algorithm which “hunts” the available EPG database for new library “entrants”. Effective “reduction” of library content may take the form of user-implemented preferences which effectively “de-activate” certain words, and/or categories of words.

The contents of library 44 are made available to relationship structure 46, as is indicated by the interconnection extending between the two blocks representing these components in FIG. 1A. If desired, library 44 may be supplied for use in a condition wherein all of its resident words are nominally treated by default to be “active” keywords, in the sense described earlier herein. Or, these supplied words may be treatable as “activatable keywords, where activation becomes a consequence of user setting of certain preferences. A system made in accordance with the present invention can readily be designed to function in either fashion. Preferably, library 44 is equipped with a text analysis capability of the kind mentioned above, whereby it substantially constantly “looks” at the full available EPG database over time, and selects and enters new, appropriate, potential keywords.

Display structure 42 functions, to some extent, as the operating heart of the system and methodology of this invention, and it is here that the appropriate algorithms that are necessary to perform many of the functions of the system are resident. These algorithms are available in different ways to (a) relationship structure 46, (b) through the relationship structure to library 44, (c) through preferences block 48 also to library 44, (d) to the user selection structure 50, and (e) of course, to the display creating structure which is present in television receiver 56. In the particular embodiment of the system now being described, and as will be illustrated later herein, control structure, in addition to being structured to furnish key support and enablement of and for the searching and navigation features of the invention, is suitably equipped further to respond to a user's “tuning” selections to effect either (a) immediate re-tuning of receiver 56, where appropriate, to a request for a “current” broadcast, and/or (b) memorizing and future implementing (turning-on and tuning-in) of “tuning requests” directed toward programming materials which are scheduled to be broadcast in the future.

Preferences block 48 represents appropriate hardware and software which may be partially resident within blocks 42 and/or 44, or may be a free-standing arrangement of structure and software, which enables a user, typically upon initial use and installation of the system and methodology of this invention, to enter certain user preferences. Such preferences enable defining, for example, of special areas of interest, and of special personalities, special kinds of events, etc., that are particularly interesting to that user. In effect, it is through the operation of preferences block 48, that a user can define whether all or only a part (or parts) of the keyword database present in library 44 will be “active” thereafter in the operation of system 40. Preferably, any initial set of preferences relating to these matters can be changed at will by the associated user simply by “calling up” an appropriate control interface (on screen 56a) that represents opportunities for changing preferences in block 48. This kind of a preference-establishing operation can be provided utilizing quite conventional structure and software.

According to practice of the present invention, with system 40 in place and operating, the incoming EPG database is compared in block 46 with preferentially active keywords that are present in library 44, thus to identify regions within the EPG database which contain references, i.e., uses, of these words. This relating of library keywords to available EPG text is referred to herein also as the relating of keywords to locate relationships with EPG text. On the basis of such a comparison (i.e., relating), and under the control of display structure 42, this relationship comparison which takes place in structure 46 produces or creates what is referred to herein as a modified EPG data stream. This modified data stream takes the form essentially of an extraction of blocks of data from within the EPG full database, and in particular, to an extraction of such blocks which contain words that are active and present as defined keywords within library 44. As has been mentioned, keywords that are considered to be “active” are either all of the keywords actually present in the library, or a smaller population of library words based upon user-entered preferences.

This modified data stream is made available through display structure 42, and at the command of a user via selection structure 50, to create and present an on-screen, interactive, interface display on screen 56a in receiver 56. Such a display is referred to herein as possessing navigational-capable keyword content. The display is also referred to as being a context manipulable presentation.

According to practice of the invention, active keywords furnish conventionally constructible links to related other portions of the EPG database. Selecting a keyword during use of the invention utilizes these links, and initiates, and enables what is referred to herein as, transport through this database to the associated, linked regions. Appropriate virtual tools, such as tab, button and scrollbar tools, may be presented to enable user browsing through plural regions which may be associated with a given linking operation

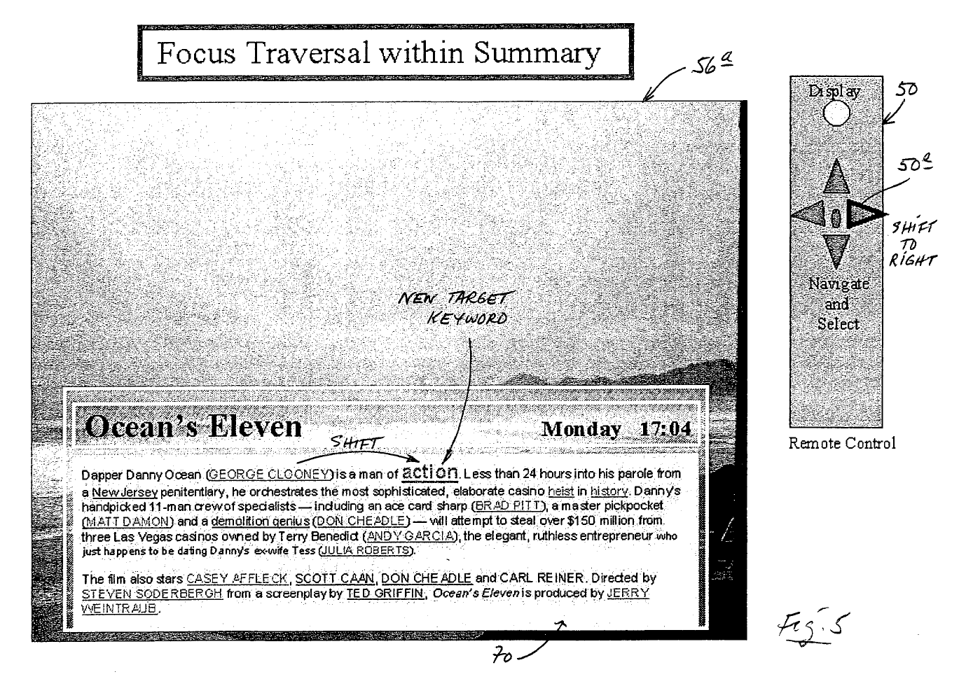

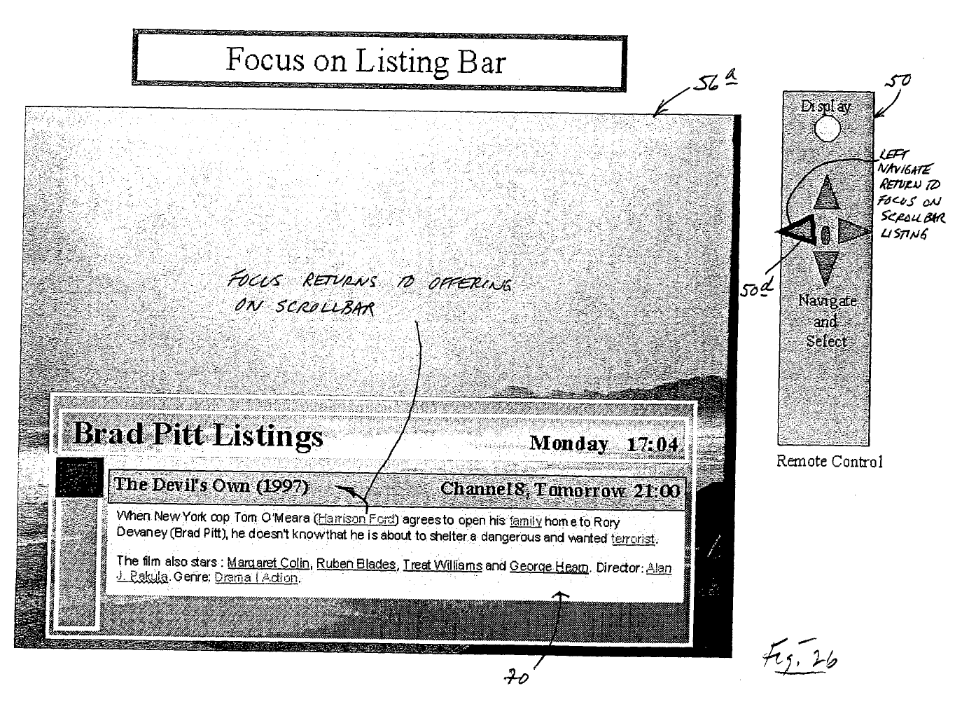

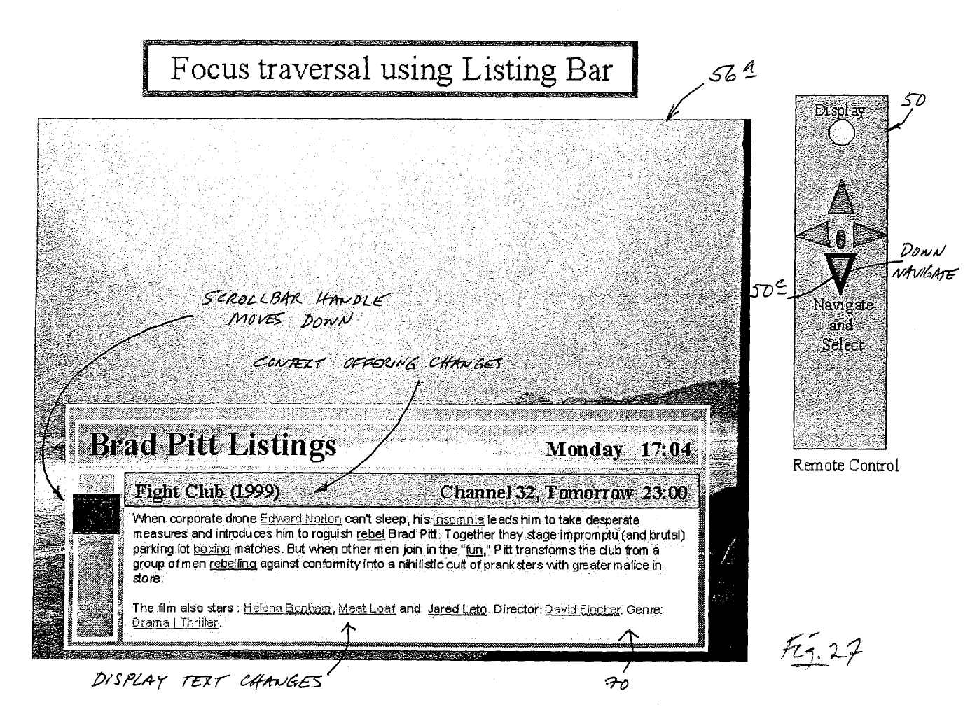

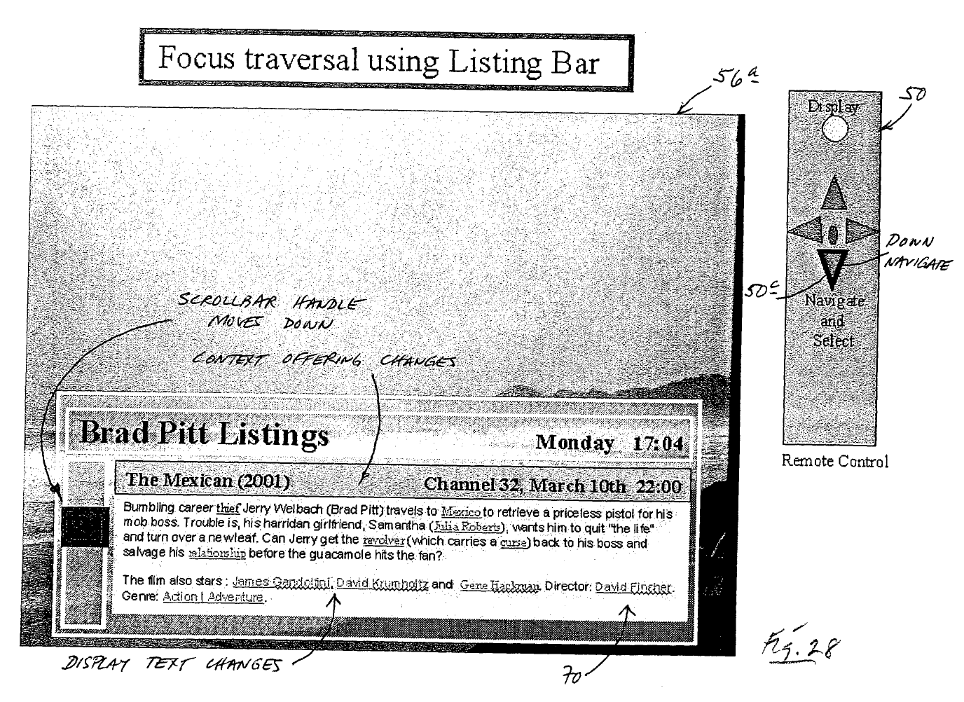

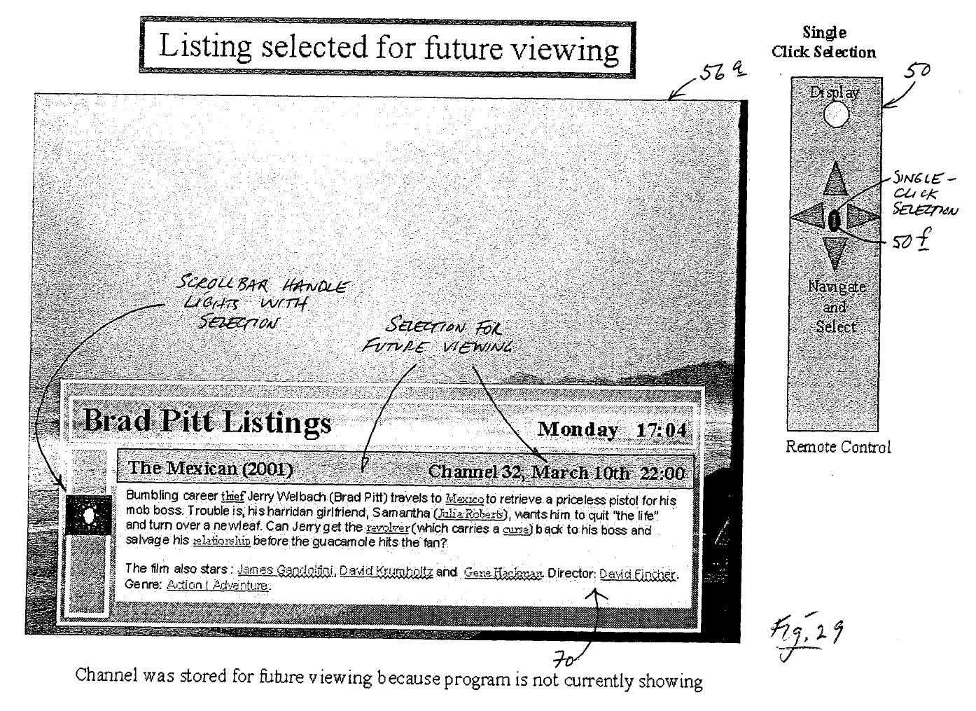

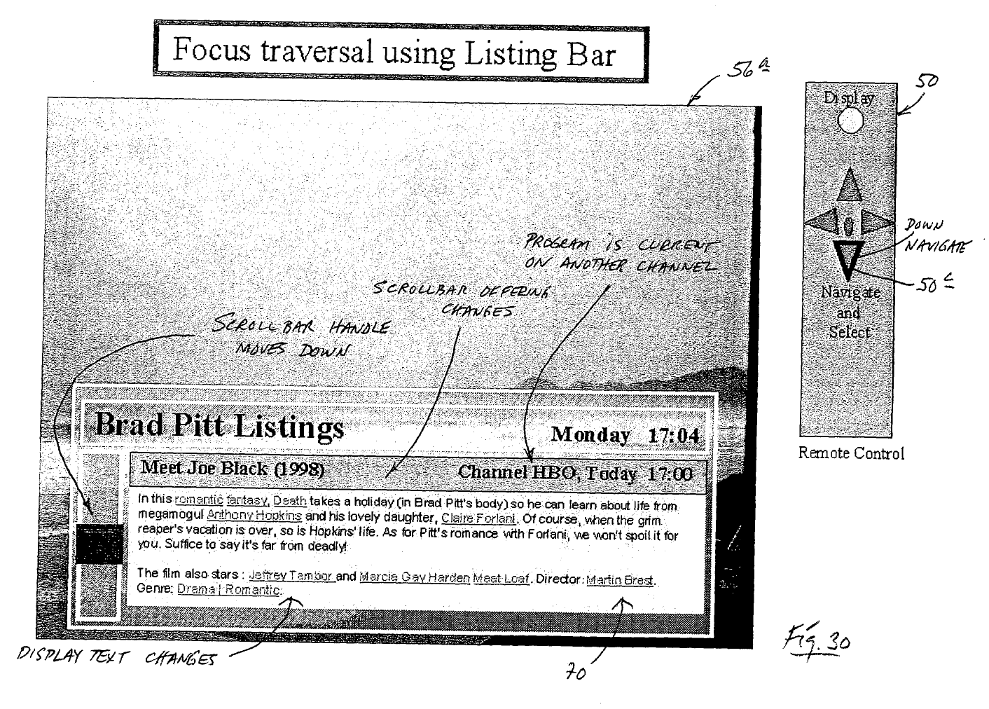

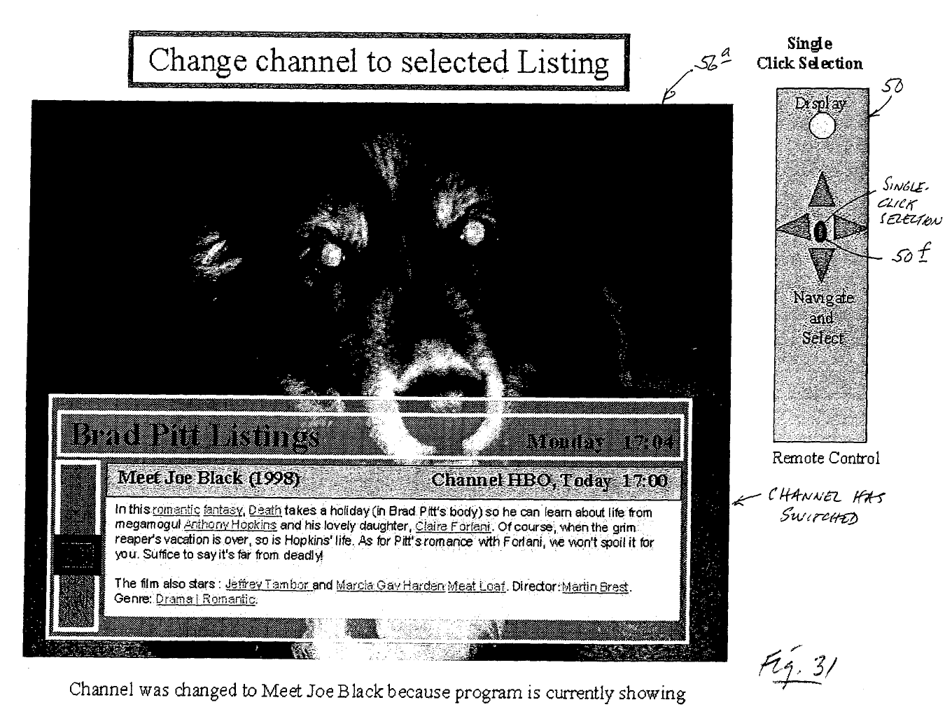

As will be explained shortly with respect to several specific illustrations of use of system 40, and in relation to FIGS. 3-31, inclusive, herein, certain different modes (two are illustrated herein) are offered to a user with respect to performing context keyword navigation, with two different levels of granularity, through the information content contained in the modified EPG data stream. As will also be seen very shortly, such a display interface, which is brought to visibility on screen 56a, contains different text presentations from the modified EPG data stream derived from the full EPG database. Such text presentations contain keywords whose presence in the text as active, navigational tools is made evident in any one of a number of different visually noticeable ways. For example, the words in this category may be highlighted with different colors, may be presented with different kinds of font styles, may be presented in different sizes, and so on. Through the use of selection structure 50 which preferably, as was mentioned, is some sort of an appropriate hand-holdable remote control device, a user can call up a display on screen 56, and can then employ the presented keyword components as navigational tools in different ways to transport through the modified EPG data stream in order to identify the availabilities, timings, etc. regarding different pieces of television programming content which suit the user's interests.

As was noted earlier, the present invention does not operate at all in the manner of conventional menu-driven interfaces. Nor does it require that a user enter, as by tedious keystrokes, any specifying information with respect to the acts of navigating freely through the extracted, modified data stream drawn from the incoming EPG database.

FIG. 1B in the drawings generally illustrates that part of the contribution made by the present invention which involves the creation of a unique, modified EPG data stream—the data stream which is capable of creating the kind of interactive navigational display that has just been generally described. Here, in FIG. 1B, a fragment of the full, available, incoming EPG database is indicated generally at 60 in a kind of “film-strip” style. What is shown specifically in FIG. 1B is, of course, a highly stylized set of graphical artifacts which help to explain generally the nature of creation, by this invention, of, and the resulting structure from, that creation relating to the referred-to modified EPG data stream.

In particular what is represented at 60 in FIG. 1B is a region, or a part, of the unmodified and fully available EPG database, within which there are represented three sub-regions 60a, 60b, 60c which are shaded and shown as having different sizes. These regions symbolize graphically certain regions within the entire EPG database that contain content information which has been predetermined, in accordance with the presence of active keywords in library 44, to be of special interest to a particular user. If the user has not implemented special preferences, then basically the entire content of library 44 represents keywords all of which will be considered to be active keywords, and with regard to which regions like regions 60a, 60b, 60c will be identified.

The horizontal, fragmentary dashed line shown at 62 in FIG. 1B represents the combined actions of blocks 42, 44, 46 in system 40, whereby regions, such as regions 60a, 60b, 60c, are identified as containing navigationally active keywords that should be made available on the screen in the interface display mentioned above. It is through the interactive cooperation of blocks 42, 44, 46, that the modified EPG data stream, shown symbolically at 64 in FIG. 1B, is created as a extract of information from the full EPG database represented at 60. In this modified data stream, as pictured graphically in FIG. 1B, one can see that an extraction has taken place with regard, for example, to highlighted region 60a in the full EPG database, and is made available as a component in the modified EPG data stream. Strictly for visualization purposes, the linear extent of region 60a is shown expanded as a region 64a within the modified data stream. Dark vertical lines, such as those shown at 66, 68 in region 64a, represent the presence of distributed keywords that are found in this extracted portion of the full EGP database. These keywords are, of course, the active linking tools employed by the system of the invention to navigate the EPG database portions which are of special interest to a user. A region of textual data present in the full EPG database which, by virtue of the comparison activity performed by structure 46, is not found to contain any “active” keywords, is not extracted to the modified EPG data stream.

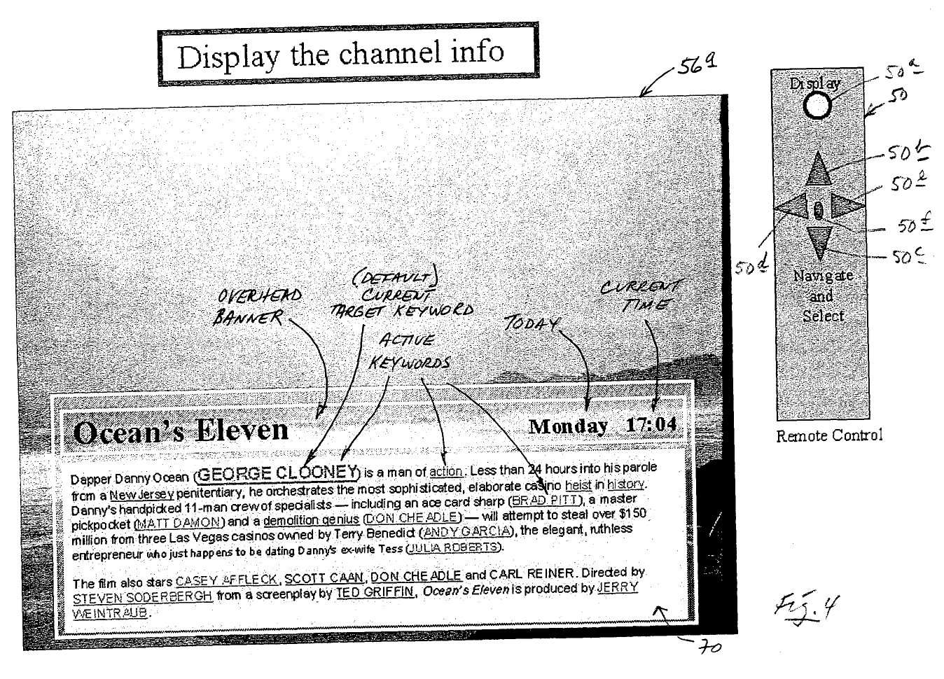

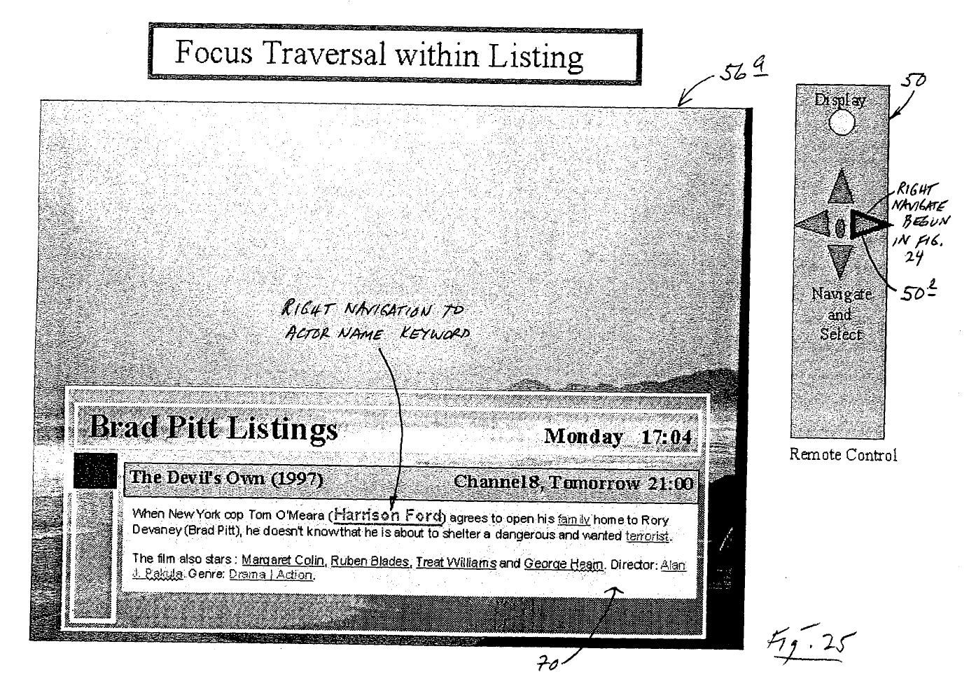

Turning attention now to the remaining drawing figures, FIGS. 3-31, inclusive, but discussing first of all how FIG. 2 describes the relationships between these figures, FIGS. 3-31, inclusive, provide respective illustrations of three different manners of use and operation of the present invention. Vertically centered in FIG. 2 is a column containing representations of FIGS. 3-13, inclusive, and one should understand that by looking in serial order from FIG. 3 to and including FIG. 13, one will observe one mode of operation of the system and methodology of this invention. Toward the left side of FIG. 2, but nonetheless beginning and ending generally vertically centrally in the figure, is another arrangement of figures which tells another operational story. This arrangement begins with FIGS. 3-6, inclusive, and then branches laterally to FIGS. 24-31, inclusive, after which it concludes with previously mentioned FIG. 13. Toward the right side of FIG. 2, there is an illustration of the third sequence of the figures which tells yet another operational story about the present invention. This sequence also begins with FIGS. 3-6, inclusive, and then branches to the string of figures including FIGS. 14-23, inclusive, after which the sequence again ends with previously mentioned FIG. 13.

Turning attention first of all to the central string of FIGS. 3-13, inclusive, FIG. 3 represents a full-screen presentation of a particular current program on a particular channel. The program pictured here is called “Oceans 11”.

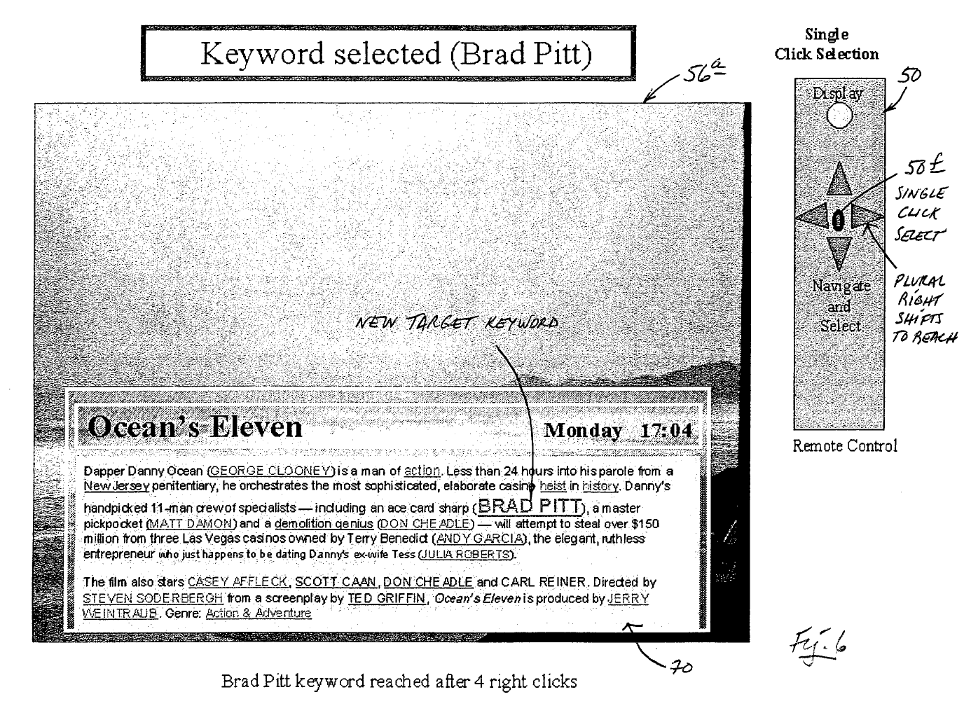

FIG. 4 illustrates a change which takes place in the display on the television screen with an initial action that is performed by a user employing remote control 50. This remote control is pictured toward the right side of FIG. 4, and can be seen to include six control buttons, 50a, 50b, 50c, 50d, 50e, 50f. Button 50a is a display command button. Buttons 50b, 50c, respectively, are up and down control buttons. Buttons 50d and 50e are, respectively, left and right control buttons. Button 50f is referred to herein as an enter button. It is through button 50f that single and double “clicks” are entered by a user to make selections.

To bring up the condition of the screen display pictured in FIG. 4, the user has activated button 50a, and this activation causes the presentation on screen 56a of an on-screen user interface display 70 which has been created in accordance with practice of the present invention. Display 70 constitutes a block of text information which has been extracted from the EPG database. This block of text provides information directly about the program currently being watched—namely the program pictured more fully in FIG. 3. One can see in this display, as an illustration, that the title of the program is pictured in an overhead banner in interface 70, and that, the day of the week, and the current time are also presented.

Below this overhead banner is a body of text drawn directly from the modified EPG data stream. Within this text, there are presented a number of navigational action keywords that are active because of their presence as “active” keywords in library 44. These keywords are shown in a differentiated and/or highlighted way in this on-screen display. By default, the keyword which resides the highest and the most to the left in the text is nominally selected to be the first keyword with respect to which a user selection action will produce a contextual display change in accordance with practice of the present invention. Thus, one can see that in FIG. 4, the actor name “George Clooney” is presented as the initially selected target for a simple selection action by a user. Such a selection action is performed by clicking enter button 50f as will be explained.

In accordance with practice of the invention, it is possible for a user, looking at display 70, to maneuver within that display utilizing control buttons 50b, 50c, 50d, and 50e, thus to cause other activated navigational keywords to become the “target” keywords for a selection action.

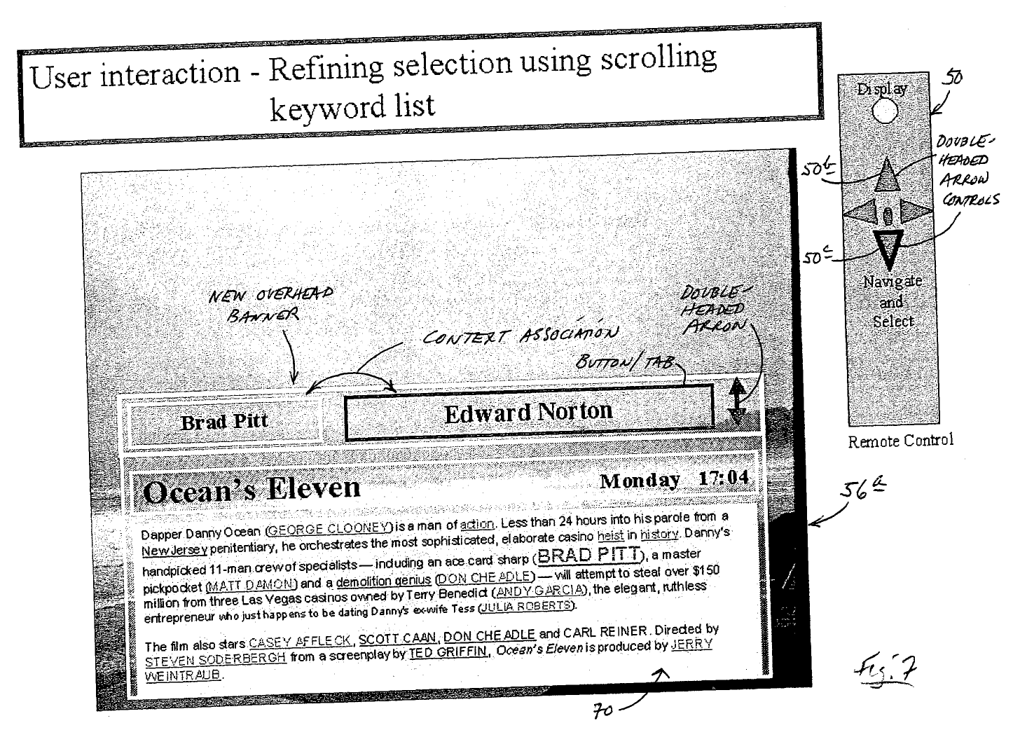

FIG. 5 in the drawing illustrates a transition, or traversal, which has occurred by use of control button 50e, to the right in the display, whereby the next active word in the text, on the same line as mentioned before containing the default” target” keyword, namely the keyword “action”, becomes the new “target” keyword.

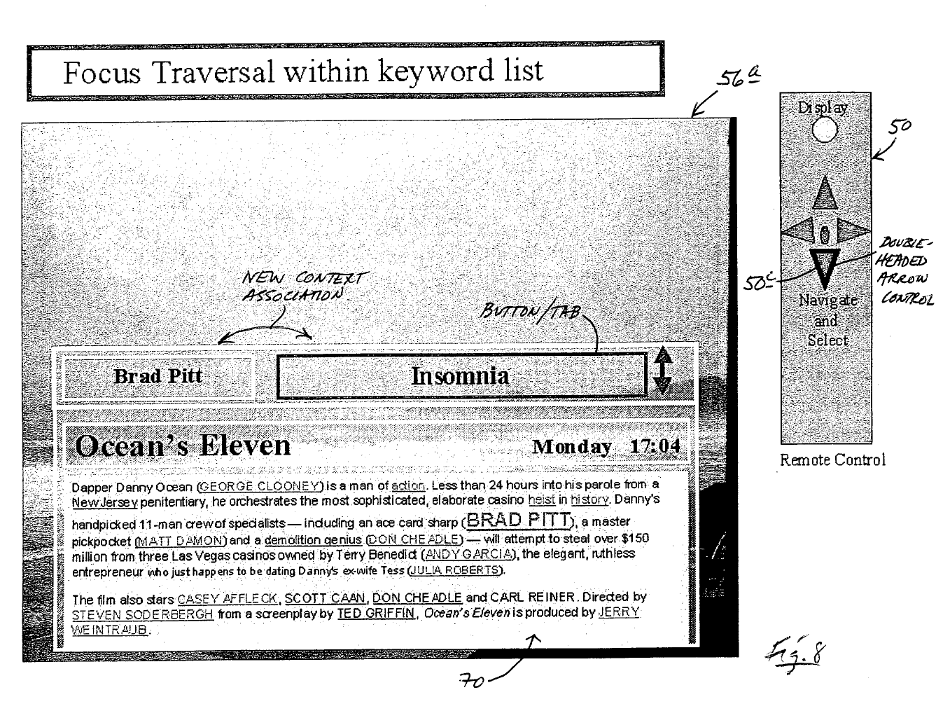

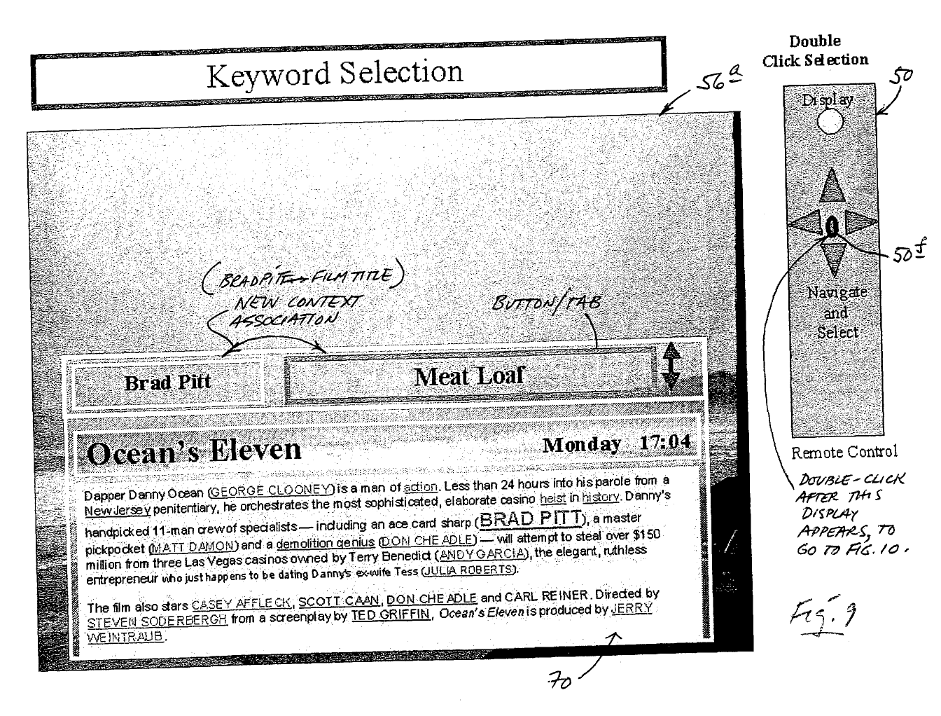

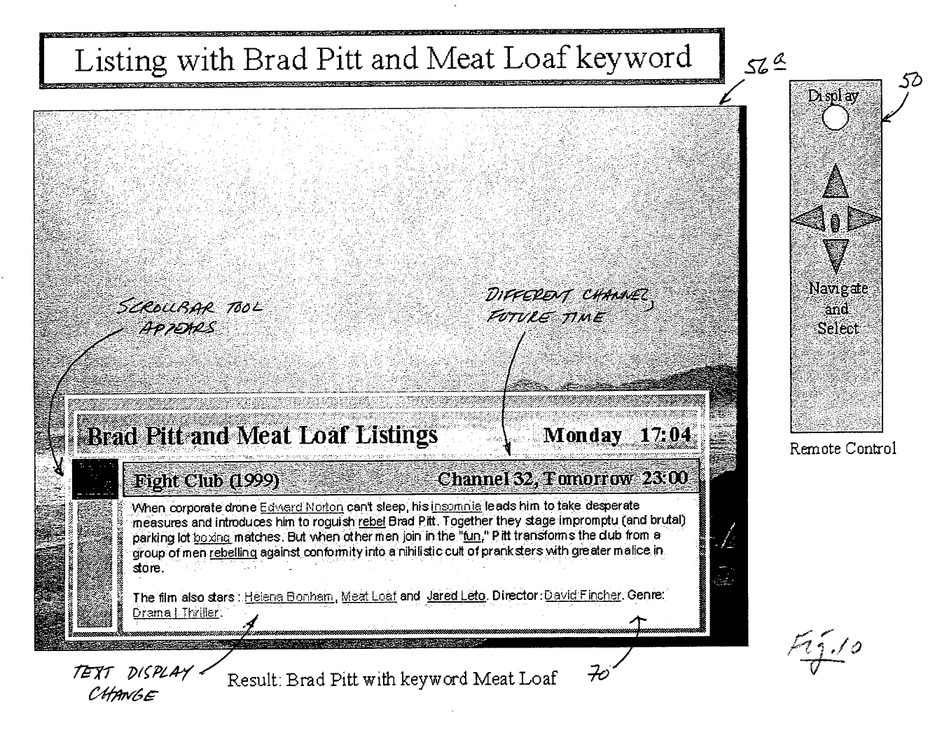

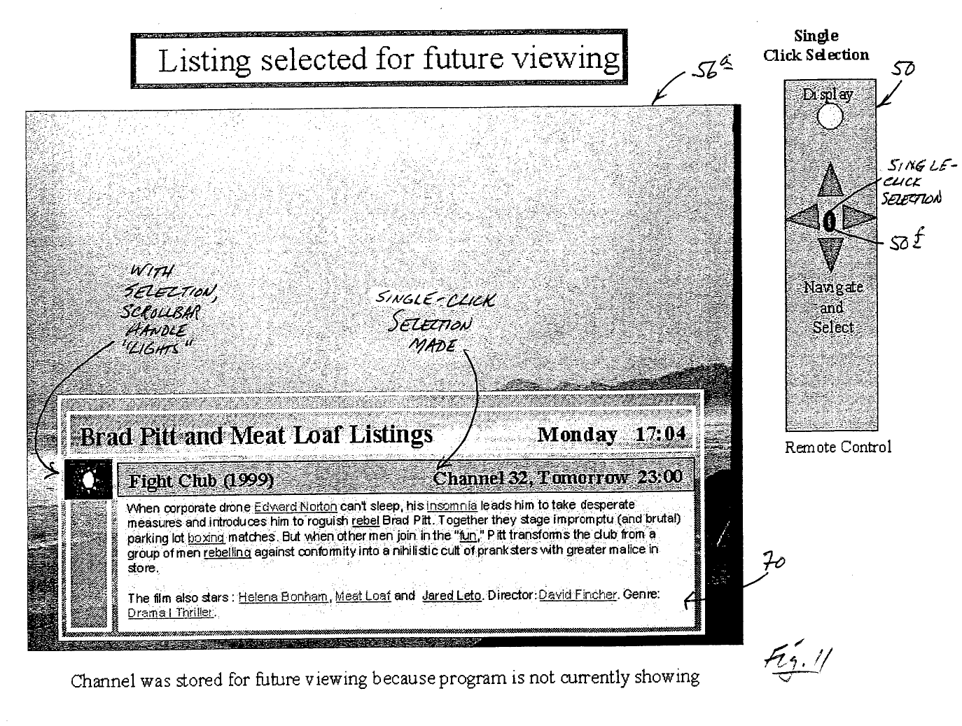

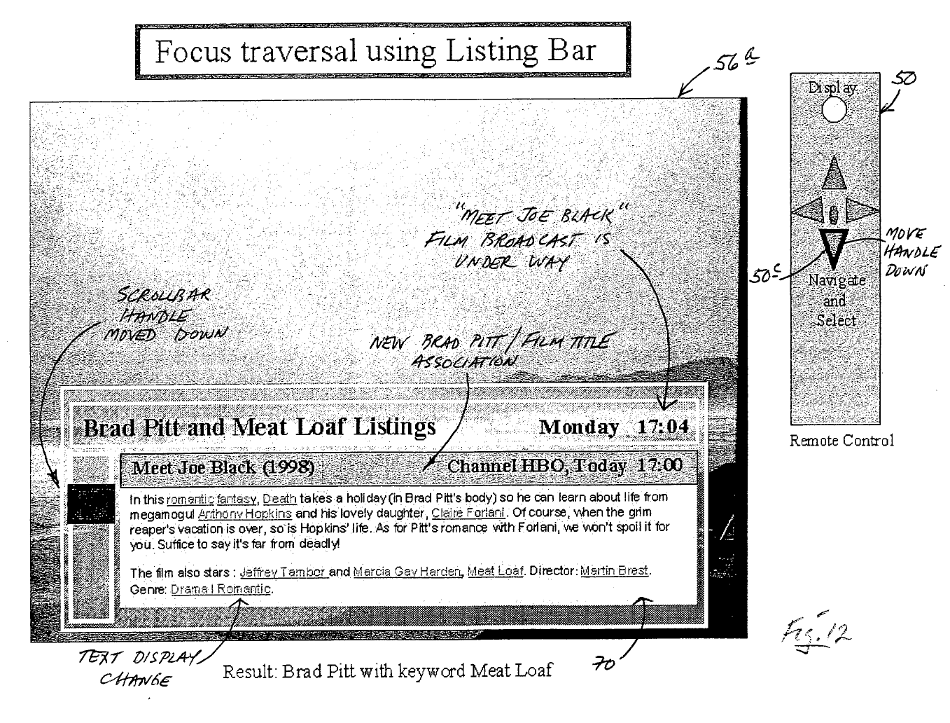

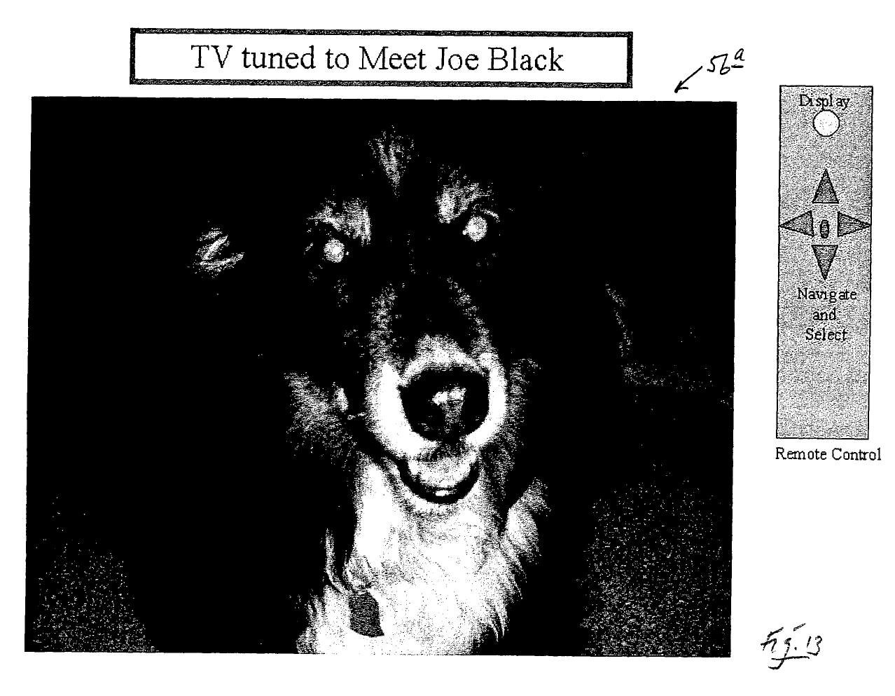

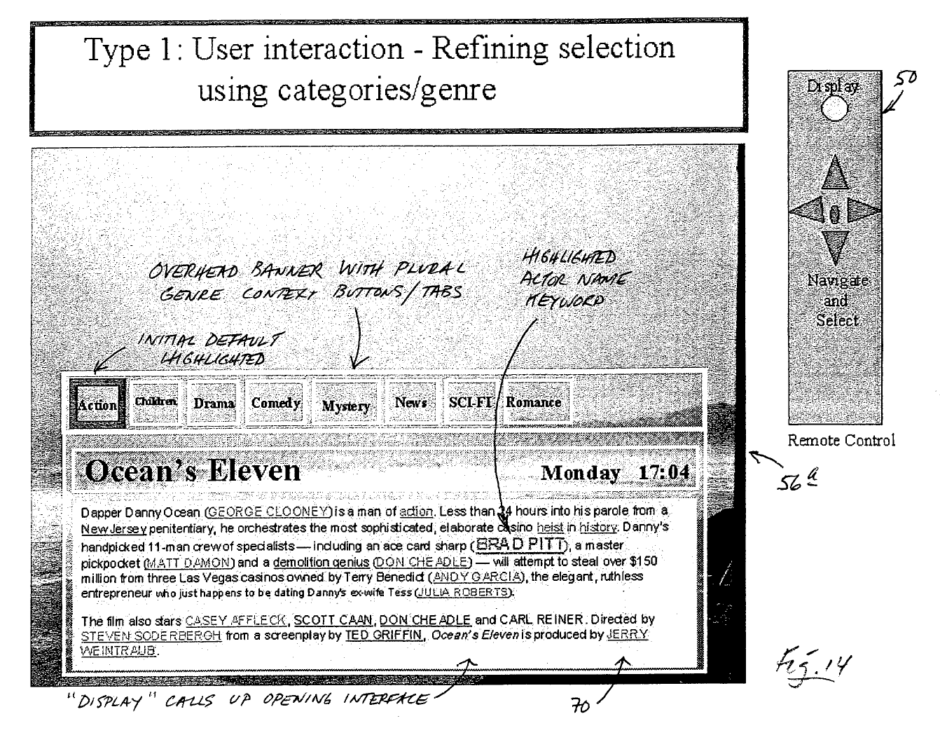

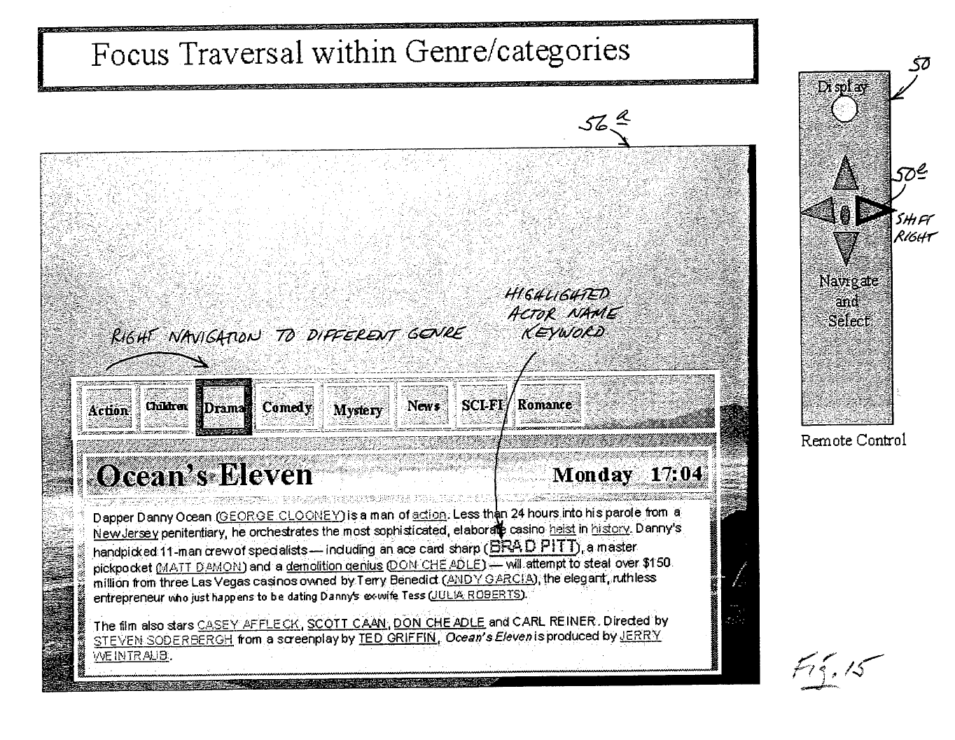

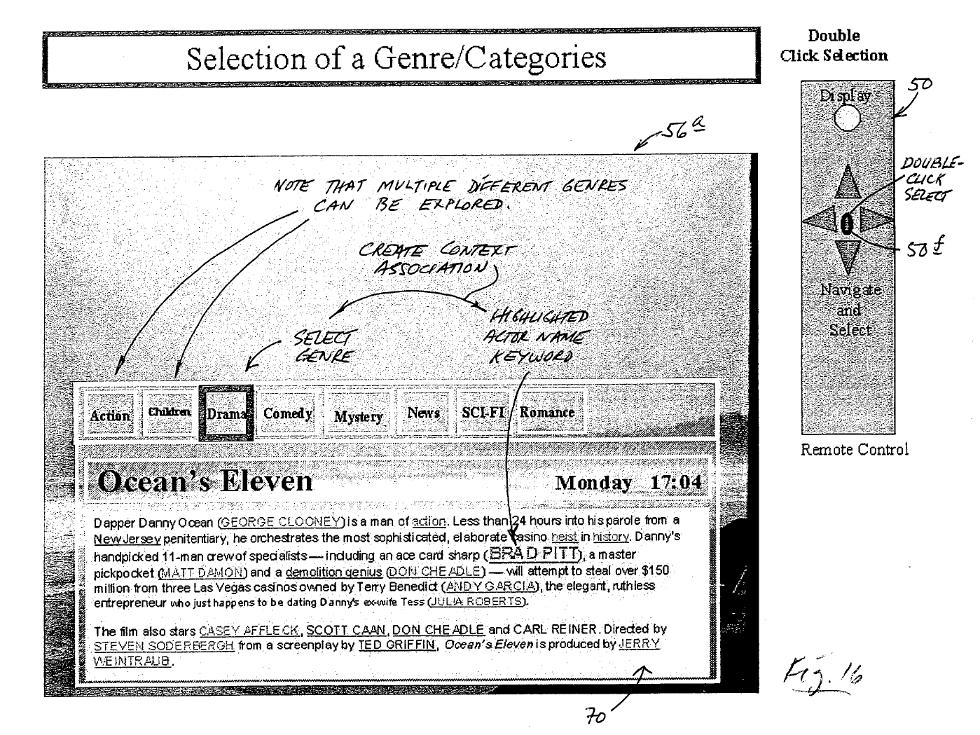

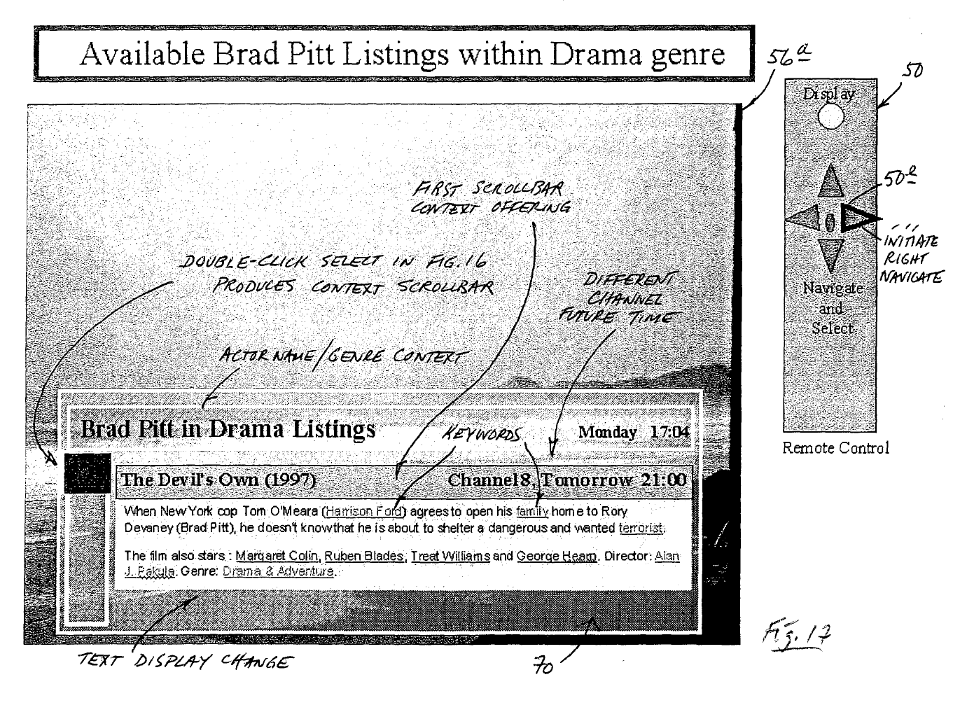

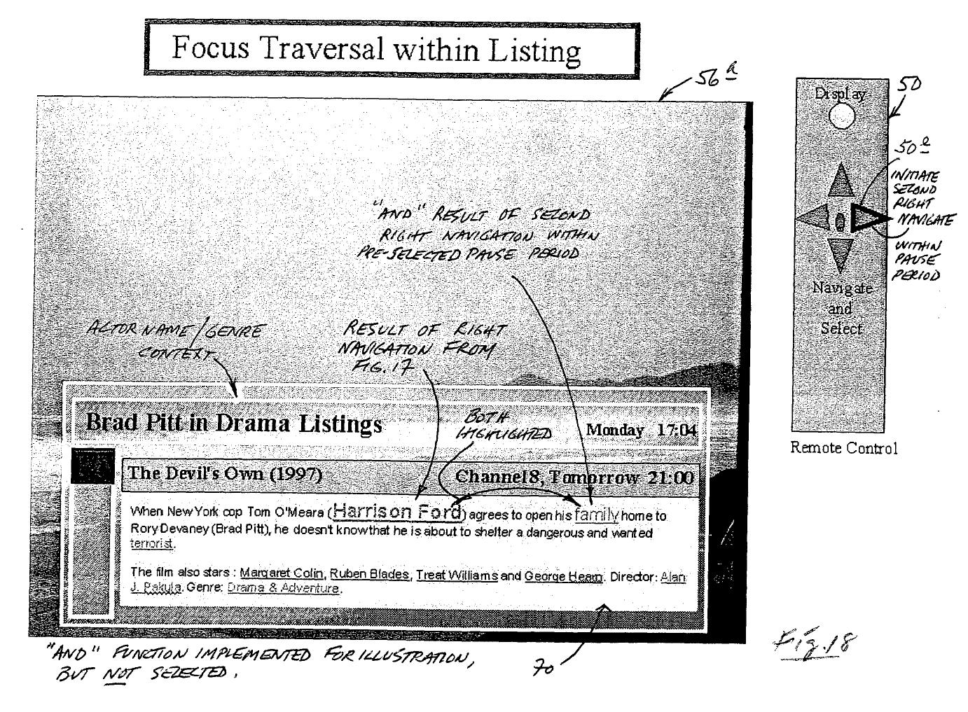

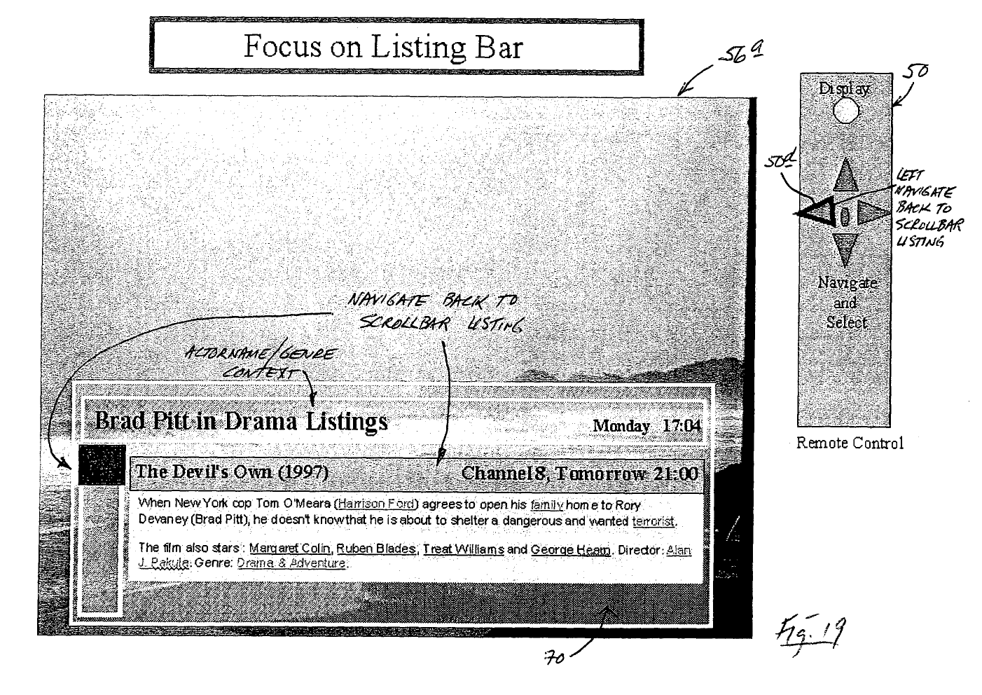

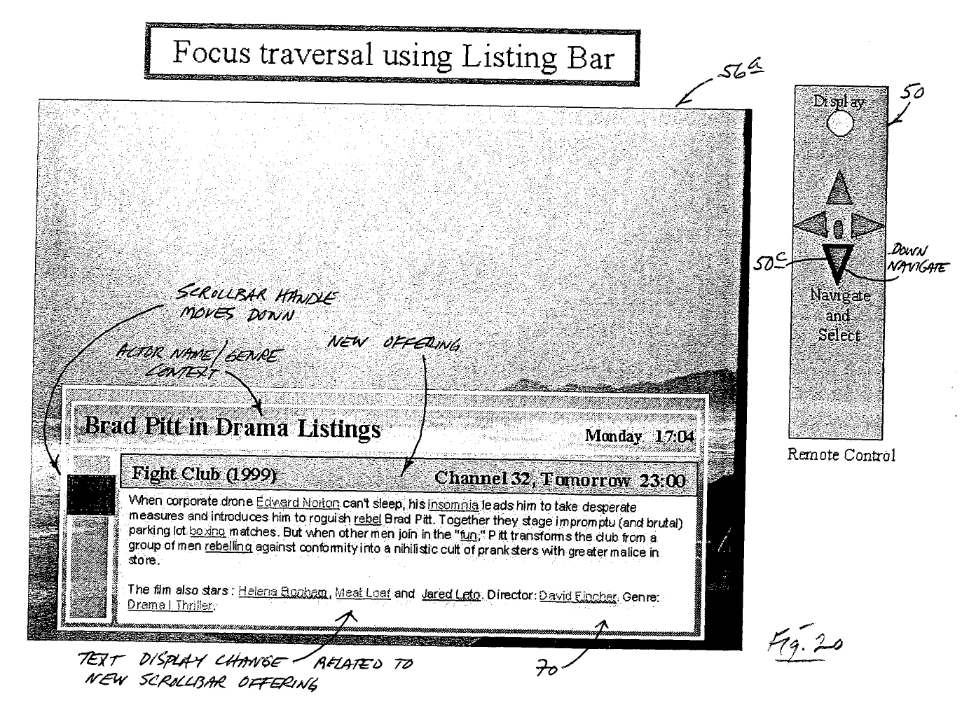

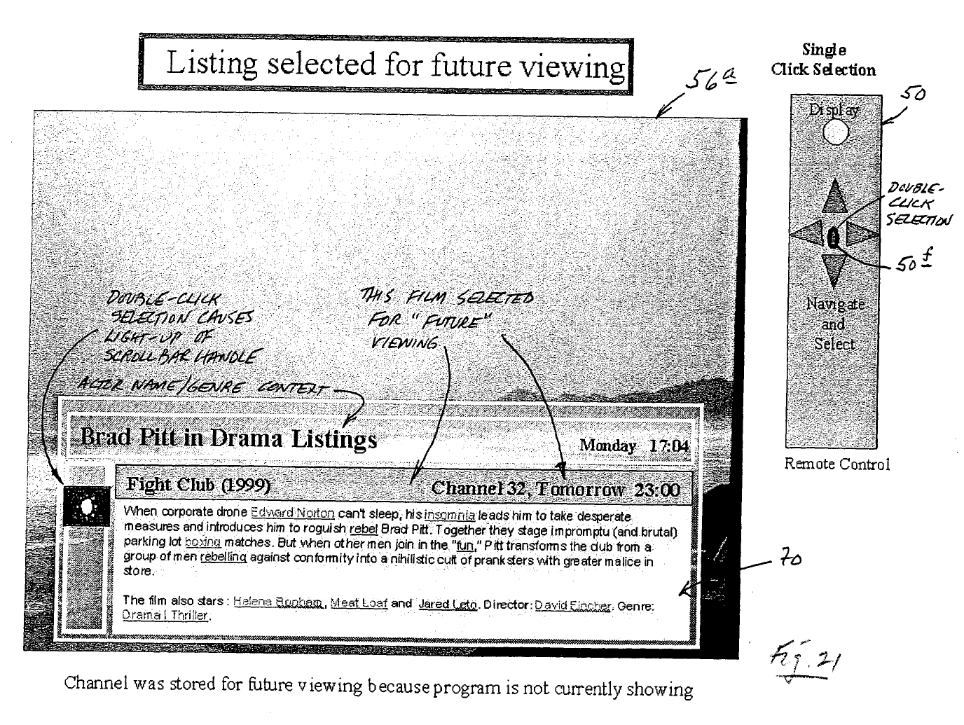

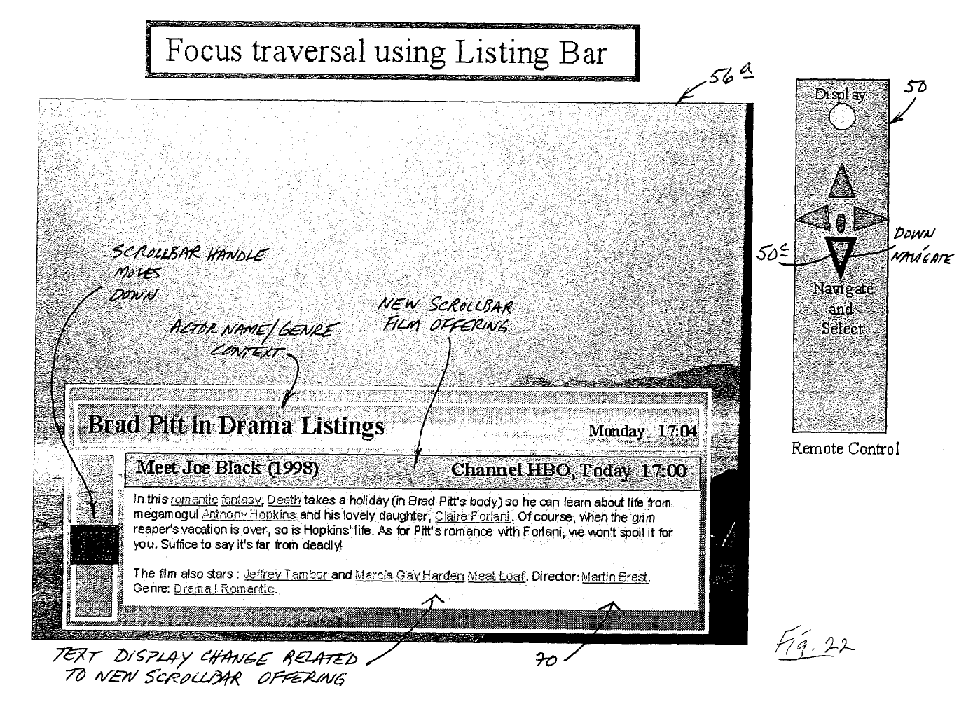

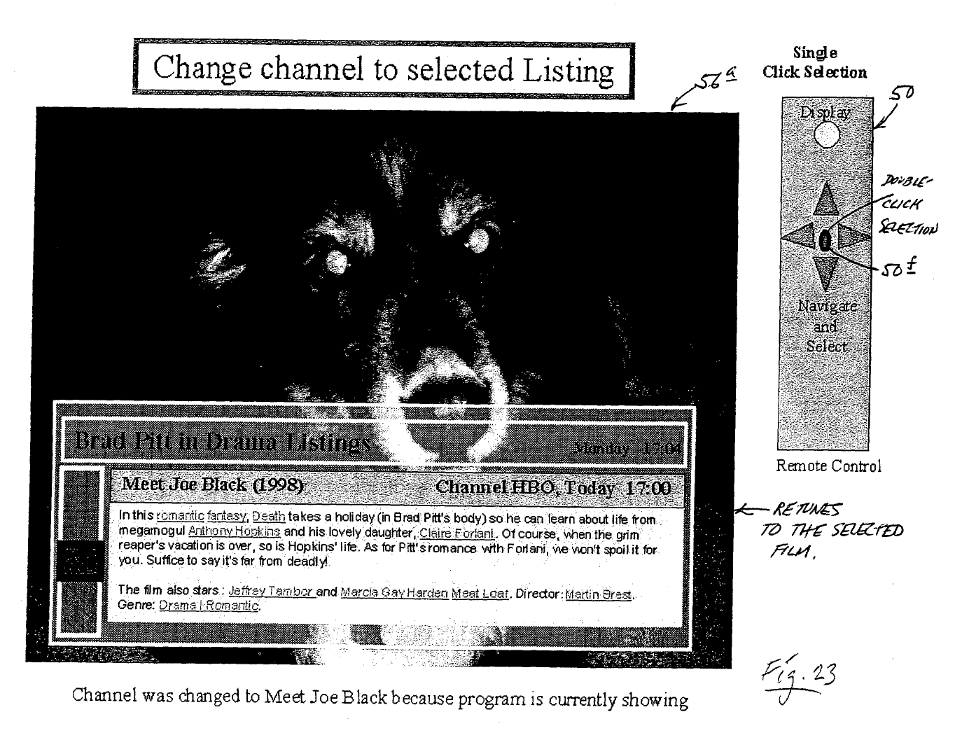

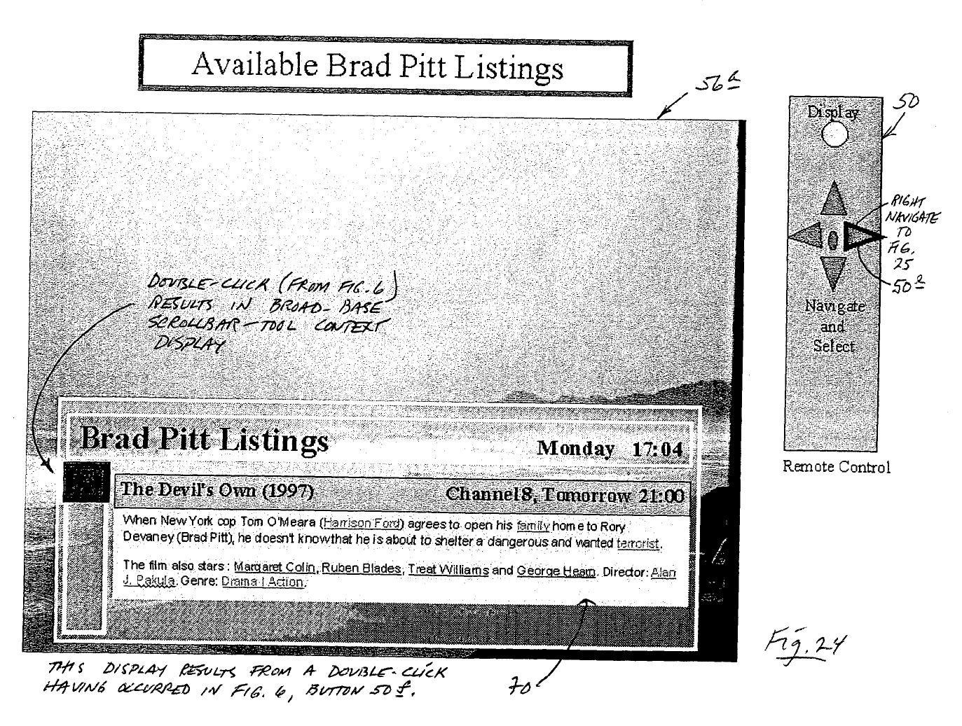

FIG. 6 illustrates a condition where the user has navigated so as to highlight the keyword actor name “Brad Pitt”. With respect to this keyword, and in the operational illustration now being given, the user makes a selection by single-clicking button 50f. Such single-clicking constitutes one mode of user navigational and selection activity provided for herein, and causes one kind of a context-informational interface display-change to take place in accordance with practice of the invention. More specifically, a single click on the enter button, after the elapse of a short, pre-selected pause period, such as three or four seconds, the reason for which pause period will be explained shortly, causes the system of this invention to bring up a context display that provides a context active tab, or button, highlighted in a new overhead banner which opens.

As can be seen in FIG. 7, this new banner presents the actor name “Edward Norton”, along with a double-headed arrow, and to the left, the actor name “brad Pitt”. The mentioned arrow signals the opportunity for the user to employ navigational buttons 50b, 50c to move through various other regions of the modified EPG data stream, so as to bring up other overhead banner context relationships for observation and possible selection, where these other relationships will include, on the left in the banner display, the name “Brad Pitt”, and on the right, other things, such as the names of other actors or film titles, as illustrations.

It is because the single-click selection just described was made with respect to the keyword “Brad Pitt”, that the new realm of selections now made available (contextually) by the overhead banner all relate to programming content that in some way involve “Brad Pitt”.

FIG. 8 in the drawings illustrates a change from FIG. 7, wherein the user has in fact so navigated by using the arrow first seen in FIG. 7, and in this illustration, has navigated to a contextually related film titled “Insomnia” which involves “Brad Pitt”.

FIG. 9 illustrates yet another “arrow-maneuvered” contextual offering which relates “Brad Pitt” to the film entitled “Meatloaf”.

FIG. 10 now illustrates another principal kind, or mode, of navigational and selection activity offered by this invention—namely, that which results from a double-click entry by button 50f. Specifically, if, in the display of FIG. 9, the user enters, with button 50f a double-click under circumstances with the film title “Meat Loaf” appearing in the right “button” in the overhead context banner, system navigational behavior now changes to a different level of navigational granularity (and character of on-screen display) subsequent behavior of which is based specifically upon the then-existing banner-displayed context relating of the actor-name keyword “Brad Pitt” to film titles (“Meat Loaf” being a film title).

Now a scrolibar-like context display appears for navigation.

Such a display—that is, a display presenting a virtual scrollbar tool for continued navigation—always , except in one situation, results from a double-click entry in the embodiment of the invention now being described and operationally illustrated. The one exception occurs where a double-click entry unambiguously signals user “selection” of a programming offering for viewing. Further, in this embodiment of the invention, only a double-click entry is effective to present the scrollbar-style tool. Single-click entries are associated differently with operation of the system, and namely, almost always with the finer-granularity categorizations of subjects presented in overhead banners via context buttons and tabs.

At this new “scrollbar” level of behavior and granularity, a level contextually uniting “Brad Pitt” with associated film titles, the first “scrollbar offering” for selection introduces the film entitled “Fight Club”, and one will note that, in the on-screen interface display of FIG. 10, new textual information is presented. With respect to the first “scrollbar informational offering” of “Fight Club”, information is given that this film will be shown “Tomorrow” at a certain time, and on a certain other channel.

If the user decides to make a selection of this future-available film, and to do so now, under the particular circumstance which currently exists with focus being directly upon the scrollbar offering, a single click is entered, the scrollbar “handle” reacts visually (see FIG. 11), and implementation of this selection to view this film takes place. Inasmuch, however, as this selected film is to be presented in the future, and given the particular structure of the system of the invention which is now being described, the user's selection is appropriately memorized in any suitable fashion, and control structure 42 prepares for automatic turning-on and proper tuning-in of receiver 56 at the right time.

If the user then moves on from the display shown in FIG. 11 to another contextual offering, for example by maneuvering the scrollbar handle downwardly with button 50c another offering appears, and such a new offering is shown in FIG. 12 which presents the film entitled “Meet Joe Black”. Here one will notice that this film is identified as being broadcast on this same day, and that its broadcast began a few minutes (17:00) before the current time of day (17:04), and thus is now under way.

If the user now single-clicks button 50f under these conditions, the television channel to be viewed switches immediately (under the control of control structure 42) to the correct channel for the “Meet Joe Black” film, and that film then appears on the screen, “accompanied” shortly by disappearance of the on-screen display interface (70).

FIG. 13 illustrates this condition.

One thing to note now about the operation which has just been described is that, while navigational and selection operations have been described so far principally with reference to the uses of single keywords, etc., another important feature of the invention is that it permits a user to combine single keyword selections by implementing a determined series of single-click entries before timeout of the “pause” interval mentioned earlier herein. This is done via appropriate display-interface maneuvering using buttons 50b, 50c, 50d, 50e to “land” successively on the several desired keywords in the current display, and by concluding multiple-keyword selections with a double-click entry. If a viewer so uses the enter button, all such selections will be combined via the equivalent of a logical “and” function, and the on-screen visible result will be a significantly narrowed and pinpointed range of focused-content display-text information.

FIGS. 3-13, inclusive, have thus illustrated use of the system of the present invention principally, though not exclusively, with respect to its important and unique, chiefly single-click utility mode. Additionally, these several drawing figures have demonstrated chiefly a systemic condition of enabled action involving a wide-ranging selection, with not too tightly pre-categorized groupings, of keywords.

FIG. 14-23, inclusive, along with FIGS. 3-6, inclusive, and FIG. 13, illustrate another similar kind of operation which can be enabled alternatively in accordance with the structuring and practice of the invention. Generally speaking, this other kind of operation is an “exclusively available” alternative to the first described kind of operation, inasmuch as it rests upon a somewhat different keyword link-establishing approach in the character and operation of library 44. The term “exclusively available” is intended to reflect the preference that system 40 be structured, from inception, to operate with either one, but not selectively and alternatingly with both, of these two different approaches. Having just said this, it is, of course, recognized, that a modification of the invention could certainly be constructed to enable both such different approaches.

The overall string of figures here which illustrates this different kind of, or approach for, operation begins with FIG. 3, goes to FIG. 6, transitions to FIG. 14, goes to FIG. 23, and then transitions to FIG. 13. This series of figures illustrates essentially a manner of operation wherein more tightly-grouped and categorized genre words, like “action”, “children”, “comedy”, “mystery”, “romance”, etc., become the contextual “granularity” areas that are “acted upon” principally with single-click button actions.

By looking now at this string of differently organized drawing figures, and observing that a different kind of context display becomes presented, one can gain a sense of the capability of the present invention to offer a very wide range of potential options for implementation in different settings. With the fairly detailed operational description that has just been given for the first series of figures mentioned above, it is believed that the operation of the system and methodology of this invention with respect to the second-mentioned series of figures is quite self evident. Appropriate action and result labeling in these figures augments the graphical picturing of events sequences.

In this series of drawing figures, FIGS. 17 and 18 collectively illustrate the earlier mentioned possibility of “and”-linking plural keywords. Two such “anded” keywords are pictured in FIG. 18. This illustration is not followed in the drawing series, however, to show “selection” based upon such “anded” keywords.

The third series of figures illustrates a slightly different kind of modal operation of the system with regard to contextual display changing. This series of figures includes FIGS. 3-6, inclusive, a transition to FIG. 24-31, inclusive, and a conclusion with FIG. 13. Fundamentally what is different here is that a user, instead of employing a series of single-click (a) broad-based keyword, and/or (b) more tightly categorized genre-type, navigational selection actions, instead employs principally double-click button actions. This double-click approach, instead of calling up the same kind of virtual, button/tab, overhead banner-type interactive display, produces instead, at least initially a scrollbar virtual-tool display which offers a user a wider ranging and less precisely focused (i.e., categorized and pre-grouped) transport through the EPG “modified” database.

With such a scrollbar maneuvering tool brought up by a double-click action, a user can maneuver the presented scrollbar upwardly and downwardly through however long a list of informational text display sections have been found in the EPG database which contain relevant contextual information possessing “active” keywords.

This third series of figures, also labeled to describe actions and results, is believed to furnish a self-explanatory description of this mode of operation of the invention. In the mode of operation illustrated by this series of drawings, again if current circumstances are such that focus is directly on a scrollbar offering, a single-click entry will select that offering.

There is thus provided and offered by the present invention a very versatile and intuitive tool enabling a user to navigate quickly, intelligently and with different degrees of focus through the usual, continually changing, very large EPG available database. No complicated menus need to be thought through or negotiated. Rather, the tools provided for navigation by the invention are highly intuitive, and easily manipulated through operation of a fairly simple and straight-forward remote control device. No tedious entries of letters and numbers to select topics is required at all. Systems made in accordance with the invention can be designed whereby the keyword database provided in a library is structured to offer different kinds of contextual behavior with respect to user navigation, and keyword, or other, selection. The three series of screen-shot figures presented herein demonstrate such possibilities

Accordingly, a preferred embodiment and method of practicing the invention, methodology associated with creating and employing a unique modified EPG data stream, and ancillary related matters, along with suggestions for variations and modifications, have been described herein. Other variations and modifications will certainly become apparent to those skilled in the art, and all such variations and modifications are believed to come within the scope of the present invention.

We claim:

1. An interactive electronic programming guide (EPG) user interface for television programming comprising
a display on the screen of a user's television receiver containing currently available EPG database supplied text, and
predetermined navigation-capable keyword content in that text, freely selectable by user action within the display to initiate navigation within the EPG database, thus to produce an EPG-informational change in the display, which change directly relates to the user-selected keyword content.

2. The interface of claim 1, wherein said keyword content is constructed to enable the initiation of different EPG navigational responses with respect to different permitted modes of user selection regarding the content.

3. The interface of claim 2, wherein such different responses lead respectively to different kinds of changes in the nature of an on-screen display of EGP textual and navigational information.

4. The interface of claim of claim 3, wherein one of such different kinds of changes introduces one form of a manipulable context presentation of EPG textual information at one granularity level in the display, and another kind of such changes introduces another form of a manipulable context presentation of EPG textual information at a different granularity level in the display.

5. The interface of claim 4, wherein said one form of context presentation presents itself in the display as a scrollbar-manipulable interface, and said other form of context presentation presents itself as a button/tab-manipulable interface.

6. A system for furnishing an interactive display of currently available electronic programming guide (EPG) textual information on the screen in a user's television receiver comprising,
display structure for creating such an on-screen display in relation to EPG textual information which is presented as an input to the display structure,
a library of navigational, action-promoting keywords which are based upon words expected nominally to be present within a currently available EPG textual database,
relationship structure operatively interposed said display structure and said library, and operatively connectable to a currently available EPG textual database, operable selectively to establish, as a presentation input to said display structure, a flow of modified EPG textual information, wherein words in the unmodified EPG textual information which have a selected relationship to keywords in said library are supplied by said display structure as visually identifiable, navigation-capable keywords in an on-screen EPG textual display thereby created by the display structure, and
selection structure operatively connected to said display structure employable by a user to perform a selection, within the on-screen EPG textual display, of at least one visually identifiable keyword presented in the display.

7. A method for enabling interactive use of an available, text-based electronic programming guide (EPG) database comprising
treating selected words in such a database text as user-selectable, navigation-active keywords, selection of which initiates related navigational transport through the database,
presenting such keyword-treated text as an on-screen interface display in a user's television receiver,
enabling user interaction with that interface in the form of keyword selection activity, and
as a response to any such keyword selection activity producing a related change in the EPG informational content presented to the user in the displayed interface.

8. A method for presenting available electronic programming guide (EPG) database information as an interactive display on the screen in a user's television receiver comprising
establishing a library of navigational, action-promoting keywords which are based upon words expected nominally to be present within a currently available EPG textual database,
relating such keywords to locate defined matching relationships with words found present in such a currently available EPG database,
as a result of said relating and locating, creating a modified EPG data stream, wherein such “matching relationship” words are treated in this data stream as navigationally active words which are selectable by a user to initiate related navigational transport through the EPG database, and
presenting as an interactive interface on the screen in a user's television receiver, for user selection, a visually readable display of EPG information drawn from the modified EPG data stream.

9. An electronic programming guide (EPG) data stream derived from, and structured as a modified form of at least a part of, an available EPG database, said data stream being effectively presentable as an interactive display on the screen in a user's television receiver, and comprising
a body of text data selected from such a database, and
within that data body pre-selected keywords that are user-selectable in such an interactive display as navigational-interface tools enabling selective navigational informational and screen-displayable transport through the data stream derivation from the EPG database.
